(19) United States
(12) Patent Application Publication
(10) Pub. No.: US 2019/0112433 A1
(43) Pub. Date: Apr. 18, 2019

(54) SOFT MATERIAL, METHOD FOR ELECTROSTATICALLY INDUCING DEFORMATION THEREIN, AND SOFT ROBOT

(71) Applicant: HON HAI PRECISION INDUSTRY CO., LTD., New Taipei (TW)

(72) Inventor: HSIU-WEN CHIEN, New Taipei (TW)

(21) Appl. No.: 15/794,465

(22) Filed: Oct. 26, 2017

(30) Foreign Application Priority Data
Oct. 13, 2017 (TW) 106135211

(51) Int. Cl. C08J 3/075; C08J 5/18; F03G 7/06; B25J 15/02

(52) U.S. Cl. CPC C08J 3/075; C08J 5/18; C08J 2300/208; B25J 15/02; C08J 2300/00; F03G 7/06

(57) ABSTRACT

A soft material comprises a film and a gel system covered by the film. The film is made of polydimethylsiloxane, polytetrafluoroethylene, polymethyl methacrylate, polyxylene, polystyrene, rubber or nylon. The gel system comprises a gel and saline solution. The gel is a polymer network structure, and the saline solution is infilled in interspaces of the polymer network structure. The film is electrostatically neutral, and the soft material has an original electrostatic equilibrium state. When the original electrostatic equilibrium state is broken by electrostatic induction (such as being rubbed by a human hand), the gel expands or shrinks. The disclosure also provides a method for auto-deforming the soft material and a soft robot using the soft material.

### FIELD

The subject matter herein generally relates to a soft material, a method for auto-deforming the soft material, and a soft robot using the soft material.

### BACKGROUND

Robots are used in a variety of fields. However, motions and actions of the robots require motors and actuators.

### BRIEF DESCRIPTION OF THE DRAWINGS

Implementations of the present technology will now be described, by way of example only, with reference to the attached figures.

FIG. 1 is a diagram of an exemplary embodiment of a soft material.

FIG. 2 is a flowchart of an exemplary embodiment of a method for auto-deforming the soft material.

FIG. 3 is a diagram of an exemplary embodiment of a soft robot.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

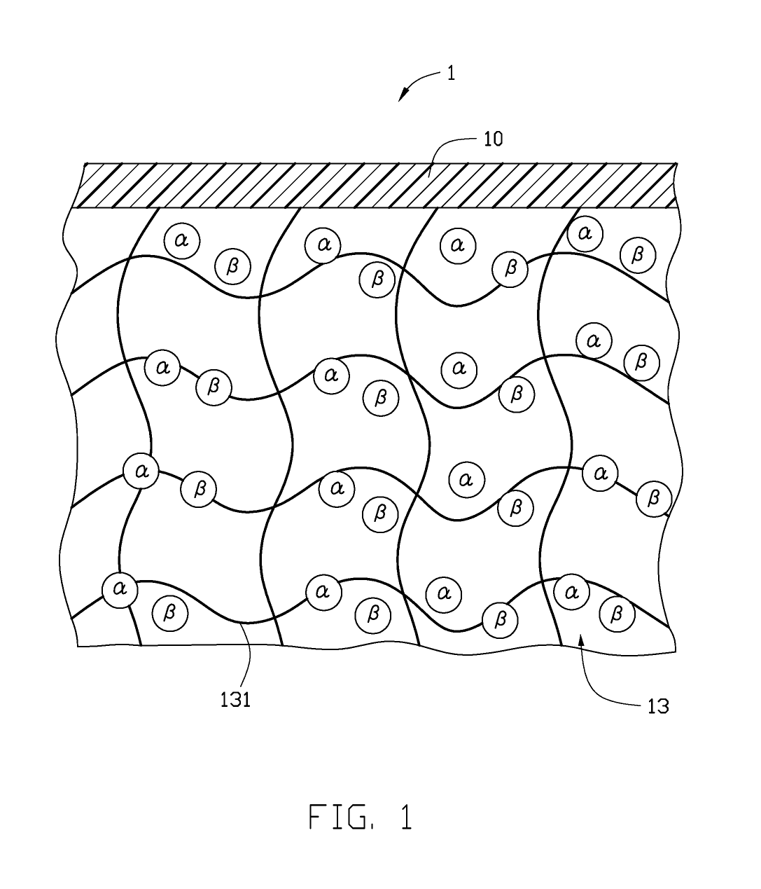

FIG. 1 illustrates an exemplary embodiment of a soft material 1. The soft material 1 comprises a film 10 and a gel system 13 covered by the film 10.

The film 10 is neutrally charged and made of polydimethylsiloxane, polytetrafluoroethylene, polymethyl methacrylate, polyxylene, polystyrene, rubber or nylon. The film 10 can be electrostatically charged under a friction of a human body, such as by a palm rubbing.

In at least one exemplary embodiment, the film 10 has a thickness of about 100 nm to about 0.2 mm. In another exemplary embodiment, the thickness of the film 10 can vary according to specific needs.

The gel system 13 has an electric field responsiveness and is in an electrostatic equilibrium state. The gel system 13 comprises a gel 131 and a saline solution. The gel 131 is a polymer network structure, and the saline solution is infilled in interspaces of the polymer network structure.

The gel 131 can be a polyanionic gel or a polycationic gel. The polyanionic gel is a polymer network structure comprising ionogenic groups, and the polymer network structure comprises ions with negative charges when the ionogenic groups are ionized. In at least one exemplary embodiment, the polyanionic gel is a polymer network structure comprising carboxylic groups, such as polyacrylic acid. The polycationic gel is a polymer network structure comprising ionogenic groups, and the polymer network structure comprises ions with positive charges when the ionogenic groups are ionized. In at least one exemplary embodiment, the polycationic gel is a polymer network structure comprising amino groups, such as chitosan or allylamine polymer.

The saline solution comprises cations α and anions β. Each cation a can be metal ion or ammonium ion, and each anion β can be acidic ion. In at least one exemplary embodiment, the saline solution comprises at least one of NaCl, KCl, Na₂CO₃, Na₂SO₄, and NaHSO₄.

In at least one exemplary embodiment, when the gel 131 is a polyanionic gel, the gel 131 has an acidity coefficient PKa of about 3 to about 4. A part of the ionogenic groups of the gel 131 is ionized in the saline solution, and is dispersed on the gel 131. Thus, the cations α and the anions β of the saline solution are evenly dispersed in the gel 131, and the soft material 1 maintains an original electrostatic equilibrium state.

When the gel 131 is a polycationic gel, the gel 131 has an acidity coefficient PKa of about 9 to about 9.5. A part of the ionogenic groups of the gel 131 is ionized in the saline solution, and is dispersed on the gel 131. Thus, the cations α and the anions β of the saline solution are evenly dispersed in the gel 131, and the soft material 1 maintains an original electrostatic equilibrium state.

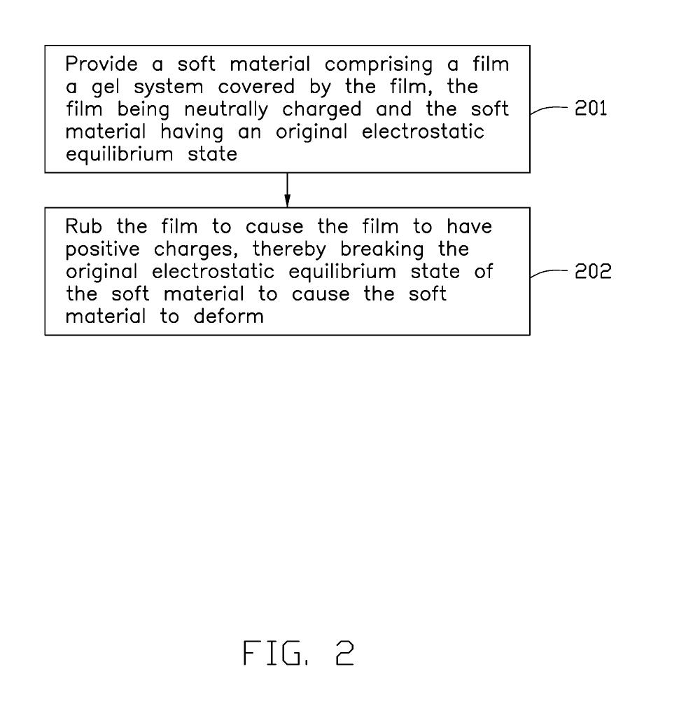

FIG. 2 illustrates a flowchart of a method for auto-deforming the soft material 1 in accordance with an exemplary embodiment. The exemplary method is provided by way of example, as there are a variety of ways to carry out the method. Each block shown in FIG. 2 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 201.

At block 201, referring to FIG. 1, a soft material 1 is provided. The soft material 1 comprises a film 10 and a gel system 13 covered by the film 10.

The film 10 is made of polydimethylsiloxane, polytetrafluoroethylene, polymethyl methacrylate, polyxylene, polystyrene, rubber or nylon. The film 10 can be electrostatically charged under a friction of a human body, such as palm rubbing.

In at least one exemplary embodiment, the film 10 has a thickness of about 100 nm to about 0.2 mm. In another exemplary embodiment, the thickness of the film 10 can vary according to specific needs.

The gel system 13 has electric field responsiveness and is in an electrostatic equilibrium state. The gel system 13 comprises a gel 131 and a saline solution. The gel 131 is a polymer network structure, and the saline solution is infilled in interspaces of the polymer network structure.

The gel 131 can be a polyanionic gel or a polycationic gel. The polyanionic gel is a polymer network structure comprising ionogenic groups, and the polymer network structure comprises ions with negative charges when the ionogenic groups are ionized. In at least one exemplary embodiment, the polyanionic gel is a polymer network structure comprising carboxylic groups, such as polyacrylic acid. The polycationic gel is a polymer network structure comprising ionogenic groups, and the polymer network structure comprises ions with positive charges when the ionogenic groups are ionized. In at least one exemplary embodiment, the polycationic gel is a polymer network structure comprising amino groups, such as chitosan or allylamine polymer.

The saline solution comprises cations α and anions β. Each cation a can be metal ion or ammonium ion, and each anion β can be acidic ion. In at least one exemplary embodiment, the saline solution comprises at least one of NaCl, KCl, Na₂CO₃, Na₂SO₄, and NaHSO₄.

In at least one exemplary embodiment, when the gel 131 is a polyanionic gel, the gel 131 has an acidity coefficient PKa of about 3 to about 4. A part of the ionogenic groups of the gel 131 is ionized in the saline solution, and is dispersed on the gel 131. Thus, the cations α and the anions β of the saline solution are evenly dispersed in the gel 131, and the soft material 1 maintains an original electrostatic equilibrium state.

When the gel 131 is a polycationic gel, the gel 131 has an acidity coefficient PKa of about 9 to about 9.5. A part of the ionogenic groups of the gel 131 is ionized in the saline solution, and is dispersed on the gel 131. Thus, the cations α and the anions β of the saline solution are evenly dispersed in the gel 131, and the soft material 1 maintains an original electrostatic equilibrium state.

At block 202, the film 10 is rubbed, for example by the palm of the hand. This causes the film 10 to have positive charges, so the original electrostatic equilibrium state of the soft material 1 is broken. Then, the anions β in the gel system 13 gather near the film 10, and the cations α move away from the film 10. The anions β gathering near the film 10 and the ions bonding on the gel 131 repel each other or attract each other, to cause the gel 131 to expand or shrink, thus deforming the soft material 1.

When the gel 131 is a polyanionic gel, the anions β gathering near the film 10 and the ions bonding on the gel 131 repel each other, to cause the gel 131 to expand, thus deforming the soft material 1. When the gel 131 is a polycationic gel, the anions β gathering near the film 10 and the ions bonding on the gel 131 attract each other, to cause the gel 131 to shrink, thus deforming the soft material 1.

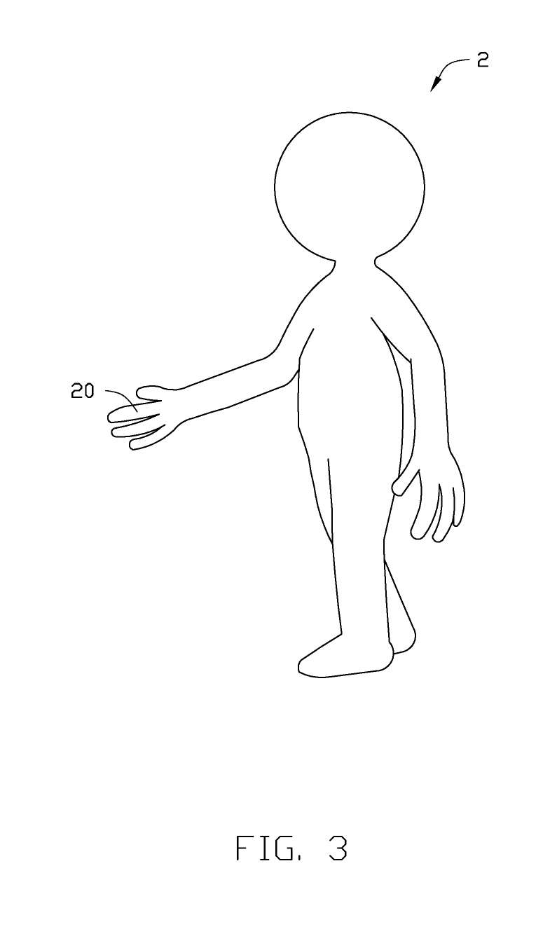

The soft material 1 can be used in soft robots or drive systems. FIG. 3 illustrates an exemplary embodiment of a soft robot 2. The soft robot 2 comprises two hands with palms (palms 20). Each palm 20 comprises a plurality of joints (not explicitly shown) made of the soft material 1. When at least one of the joints is rubbed (such as by a human palm), the at least one of the joints deforms, to cause the palm 20 to deform. The palm 20 can handshake or can make a grab without an electronic element (such as actuator).

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A soft material comprising:
a film made of polydimethylsiloxane, polytetrafluoroethylene, polymethyl methacrylate, polyxylene, polystyrene, rubber or nylon; and
a gel system covered by the film;
wherein the gel system comprises a gel and saline solution, the gel is a polymer network structure, the saline solution is infilled in interspaces of the polymer network structure, the film is neutrally charged and the soft material has an original electrostatic equilibrium state, when the original electrostatic equilibrium state is broken, the gel expands or shrinks.

2. The soft material of claim 1, wherein the film has a thickness of about 100 nm to about 0.2 mm.

3. The soft material of claim 1, wherein the polyanionic gel is a polymer network structure comprising carboxylic groups, and the gel has an acidity coefficient PKa of about 3 to about 4.

4. The soft material of claim 1, wherein the polycationic gel is a polymer network structure comprising amino groups, and the gel has an acidity coefficient PKa of about 3 to about 4.

5. A method for auto-deforming the soft material comprising:
providing a soft material comprising:
a film made of polydimethylsiloxane, polytetrafluoroethylene, polymethyl methacrylate, polyxylene, polystyrene, rubber or nylon; and
a gel system covered by the film;
wherein the gel system comprises a gel and saline solution, the gel is a polymer network structure, the saline solution is infilled in interspaces of the polymer network structure, the film is neutrally charged and the soft material has an original electrostatic equilibrium state; and
rubbing the film to cause the film to have positive charges, thereby breaking the original electrostatic equilibrium state of the soft material, wherein anions in the gel system gather nearby the film, the anions and the gel repel each other or attract each other, when the anions and the gel repel each other, the gel expands to cause the soft material to deform, when the anions and the gel attract each other, the gel shrinks to cause the soft material to deform.

6. The method of claim 5, wherein the film has a thickness of about 100 nm to about 0.2 mm.

7. The method of claim 5, wherein the polyanionic gel is a polymer network structure comprising carboxylic groups, and the gel has an acidity coefficient PKa of about 3 to about 4.

8. The method of claim 5, wherein the polycationic gel is a polymer network structure comprising amino groups, and the gel has an acidity coefficient PKa of about 3 to about 4.

9. A soft robot comprising:
at least one palm comprising a plurality of joints made of a soft material, the soft material comprising:
a film made of polydimethylsiloxane, polytetrafluoroethylene, polymethyl methacrylate, polyxylene, polystyrene, rubber or nylon; and
a gel system covered by the film;
wherein the gel system comprises a gel and saline solution, the gel is a polymer network structure, the saline solution is infilled in interspaces of the polymer network structure, the film is neutrally charged and the soft material has an original electrostatic equilibrium state, when the original electrostatic equilibrium state is broken, the gel expands or shrinks.

10. The soft robot of claim 9, wherein film has a thickness of about 100 nm to about 0.2 mm.

11. The soft robot of claim 9, wherein the polyanionic gel is a polymer network structure comprising carboxylic groups, and the gel has an acidity coefficient PKa of about 3 to about 4.

12. The soft robot of claim 9, wherein the polycationic gel is a polymer network structure comprising amino groups, and the gel has an acidity coefficient PKa of about 3 to about 4.
